(19) United States
(12) Patent Application Publication
(10) Pub. No.: US 2015/0288314 A1
(43) Pub. Date: Oct. 8, 2015

(54) MOTOR SYSTEM, MOTOR, AND DRIVE CIRCUIT

(71) Applicant: KABUSHIKI KAISHA YASKAWA DENKI, Kitakyushu-shi (JP)

(72) Inventor: Tuyoshi NONAKA, Kitakyushu-shi (JP)

(73) Assignee: KABUSHIKI KAISHA YASKAWA DENKI, Kitakyushu-shi (JP)

(21) Appl. No.: 14/742,708

(22) Filed: Jun. 18, 2015

Related U.S. Application Data
(63) Continuation of application No. PCT/JP2012/082971, filed on Dec. 19, 2012.

(51) Int. Cl. H02P 25/22; H02K 1/27; H02K 3/28; H02K 16/02; H02K 1/08; H02K 19/10

(52) U.S. Cl. CPC H02P 25/22; H02K 1/08; H02K 19/103; H02K 3/28; H02K 16/02; H02K 1/2726

(57) ABSTRACT

A motor system includes a motor and a circuit. The motor includes a mover and a stator. The mover includes mover side protrusions. The stator includes first and second stator side protrusions, and first and second coils respectively wound around the first and second stator side protrusions. When a center of one first stator side protrusion among the first stator side protrusions in a circumferential direction is aligned with a center of one mover side protrusion in the circumferential direction, a center of one second stator side protrusion among the second stator side protrusions in the circumferential direction is out of alignment with a center of another mover side protrusion in the circumferential direction. The circuit drives the motor, and includes first and second circuits to provide a current respectively through the first and second coils.

### CROSS-REFERENCE TO RELATED APPLICATIONS

The present application is a continuation application of International Application No. PCT/JP2012/082971, filed Dec. 19, 2012. The contents of this application are incorporated herein by reference in their entirety.

### BACKGROUND

1. Field of the Invention

The embodiments disclosed herein relate to a motor system, a motor, and a drive circuit.

2. Discussion of the Background

Japanese Unexamined Patent Application Publication No. 2007-244024 discloses a switched reluctance motor that includes a mover and a stator. The mover includes a plurality of protrusions. The stator includes a plurality of protrusions with coils wound around the protrusions.

In the switched reluctance motor disclosed in Japanese Unexamined Patent Application Publication No. 2007-244024, the coils wound around the protrusions of the stator are five-phased coils. The coil of each phase is coupled with an independent drive circuit to provide a flow of current individually through the coil of each phase. Thus, the switched reluctance motor is driven on a five-phase basis. Driving the switched reluctance motor on a five-phase basis reduces torque ripple (which is a range in which torque fluctuates during driving of the switched reluctance motor).

### SUMMARY

According to one aspect of the present disclosure, a motor system includes a motor and a drive circuit. The motor includes a mover and a stator. The mover includes a plurality of mover side protrusions. The stator includes first stator side protrusions, second stator side protrusions, first three-phase coils, and second three-phase coils. When a center of one first stator side protrusion among the first stator side protrusions in a circumferential direction of the motor is aligned with a center of one mover side protrusion among the plurality of mover side protrusions in the circumferential direction, a center of one second stator side protrusion among the second stator side protrusions in the circumferential direction is out of alignment with a center of another mover side protrusion among the plurality of mover side protrusions in the circumferential direction. The first three-phase coils are respectively wound around the first stator side protrusions. The second three-phase coils are respectively wound around the second stator side protrusions. The drive circuit is configured to drive the motor, and includes a first three-phase drive circuit and a second three-phase drive circuit. The first three-phase drive circuit is configured to provide a current through the first three-phase coil. The second three-phase drive circuit is configured to provide a current through the second three-phase coil.

According to another aspect of the present disclosure, a motor includes a mover and stator. The mover includes a plurality of mover side protrusions. The stator includes first stator side protrusions, second stator side protrusions, first three-phase coils, and second three-phase coils. When a center of one first stator side protrusion among the first stator side protrusions in a circumferential direction of the motor is aligned with a center of one mover side protrusion among the plurality of mover side protrusions in the circumferential direction, a center of one second stator side protrusion among the second stator side protrusions in the circumferential direction is out of alignment with a center of another mover side protrusion among the plurality of mover side protrusions in the circumferential direction. The first three-phase coils are respectively wound around the first stator side protrusions. The second three-phase coils are respectively wound around the second stator side protrusions. The first three-phase coils and the second three-phase coils are provided with a current respectively from a pair of three-phase drive circuits.

According to the other aspect of the present disclosure, a drive circuit is applicable to a motor. The motor includes a mover and stator. The mover includes a plurality of mover side protrusions. The stator includes first stator side protrusions, second stator side protrusions, first three-phase coils, and second three-phase coils. When a center of one first stator side protrusion among the first stator side protrusions in a circumferential direction of the motor is aligned with a center of one mover side protrusion among the plurality of mover side protrusions in the circumferential direction, a center of one second stator side protrusion among the second stator side protrusions in the circumferential direction is out of alignment with a center of another mover side protrusion among the plurality of mover side protrusions in the circumferential direction. The first three-phase coils are respectively wound around the first stator side protrusions. The second three-phase coils are respectively wound around the second stator side protrusions. The first three-phase coils and the second three-phase coils are provided with a current respectively from a pair of three-phase drive circuits.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a cross-sectional view of a switched reluctance motor according to a first embodiment;

FIG. 2 is a front view of a stator and a rotor of the switched reluctance motor according to the first embodiment;

FIG. 3 is an exploded perspective view of the stator of the switched reluctance motor according to the first embodiment;

FIG. 4 is a circuit diagram of a drive circuit of the switched reluctance motor according to the first embodiment;

FIG. 5 illustrates how the switched reluctance motor according to the first embodiment operates;

FIG. 6 is a perspective view of a stator and a rotor of a switched reluctance motor according to a second embodiment;

FIG. 7 is a perspective view of coils and the rotor of the switched reluctance motor according to the second embodiment;

FIG. 8 is a front view, on the anti-load side, of the stator and the rotor of the switched reluctance motor according to the second embodiment;

FIG. 9 is a front view of, on the load side, of the stator and the rotor of the switched reluctance motor according to the second embodiment;

FIG. 10 is illustrates how the switched reluctance motor according to the second embodiment operates;

FIG. 11 is a cross-sectional view of a switched reluctance motor according to a third embodiment; and

FIG. 12 is a perspective view of a magnet of the switched reluctance motor according to the third embodiment.

### DESCRIPTION OF THE EMBODIMENTS

The embodiments will now be described with reference to the accompanying drawings, wherein like reference numerals designate corresponding or identical elements throughout the various drawings.

### First Embodiment

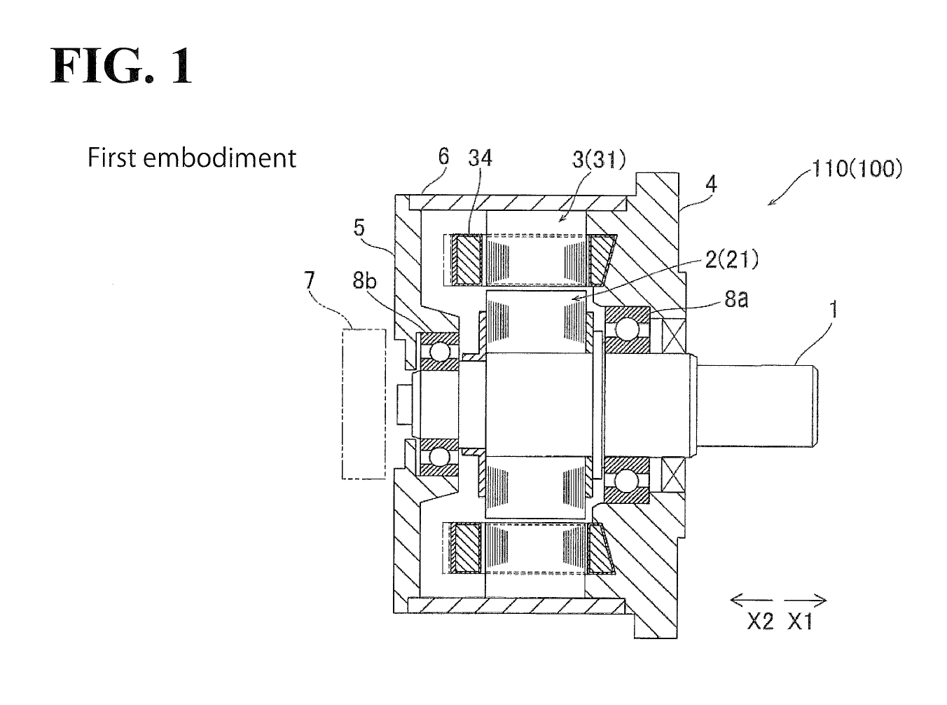

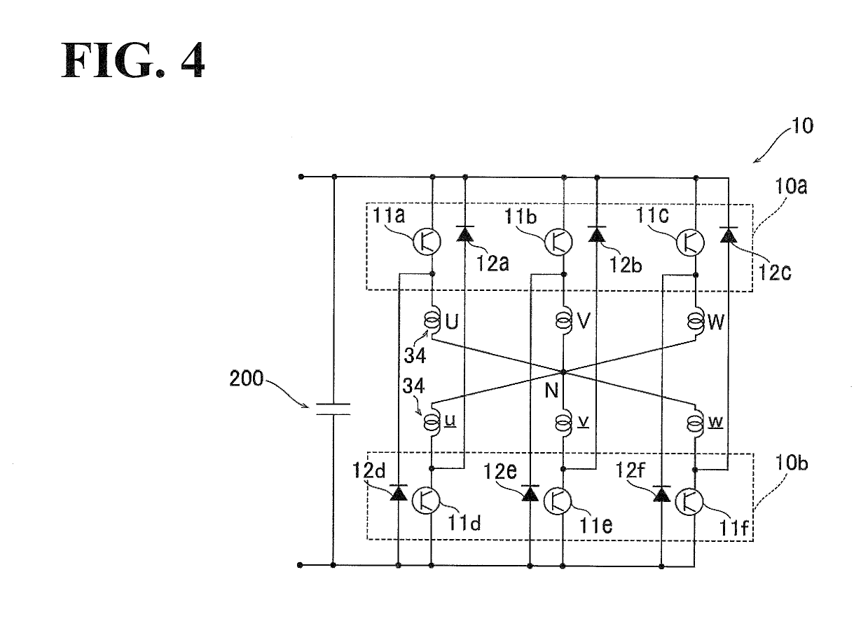

First, by referring to FIGS. 1 to 4, a configuration of a motor system 110 according to the first embodiment will be described. The motor system 110 includes a switched reluctance motor 100 (see FIGS. 1 to 3) and a drive circuit 10 (see FIG. 4). The switched reluctance motor 100 is an example of the “motor”.

As illustrated in FIG. 1, the switched reluctance motor 100 includes a shaft 1, a rotor 2, a stator 3, a load side bracket 4, an anti-load side bracket 5, a frame 6, and an encoder 7. The stator 3 is mounted on the frame 6. The rotor 2 and the stator 3 are opposed to each other and covered with the load side bracket 4 and the anti-load side bracket 5. The encoder 7 is disposed on the arrow X2 direction side of the shaft 1. The rotor 2 is an example of the “mover”. The stator 3 is an example of the “stator”.

The rotor 2 includes an approximately cylindrical rotor core 21. The rotor core 21 is made up of laminated steel plates. The rotor 2 (the rotor core 21) is mounted on the shaft 1. The shaft 1 is rotatably supported by a load side bearing 8a on the arrow X1 direction side of shaft 1 and by an anti-load side bearing 8b on the arrow X2 direction side of shaft 1. This makes the rotor 2 rotatable.

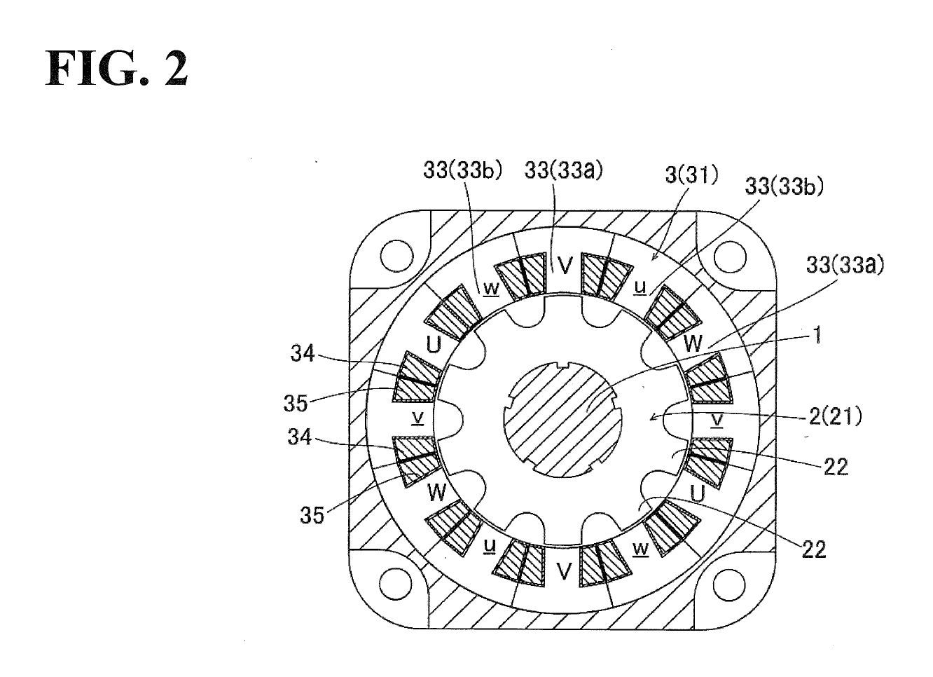

In the first embodiment, as illustrated in FIG. 2, the rotor 2 (the rotor core 21) includes a plurality of protrusions 22 (10 protrusions 22 in the first embodiment). That is, the rotor 2 has a pole number of 10, which corresponds to the number of the protrusions 22. The protrusions 22 are examples of the “mover side protrusions”.

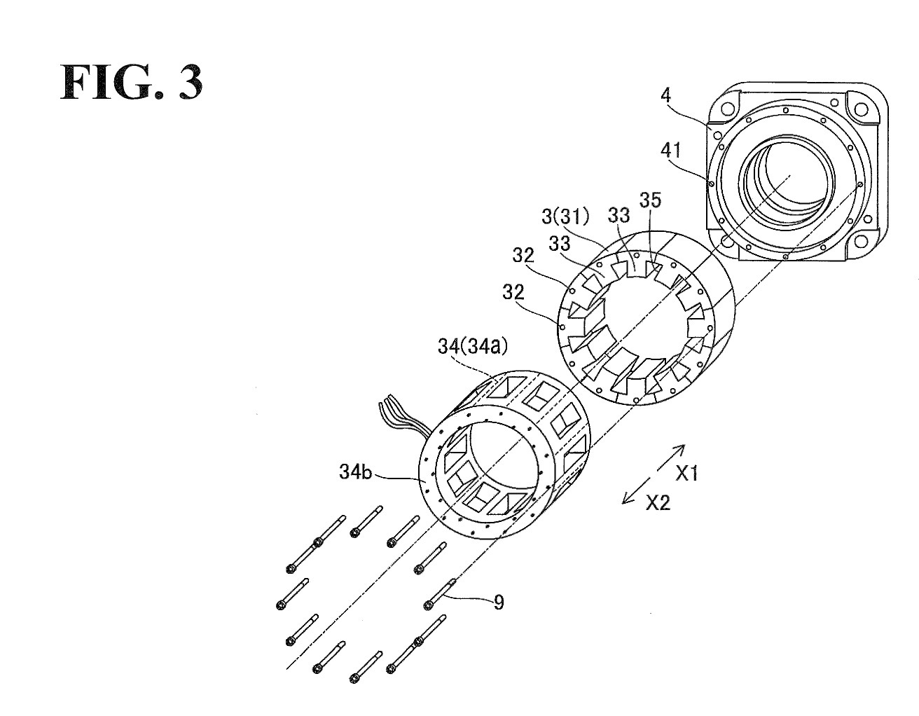

The stator 3 includes a stator core 31. The stator core 31 is made up of laminated steel plates. As illustrated in FIG. 3, the stator core 31 has a plurality of stator core 31 divisions (12 divisions in the first embodiment). Each stator core 31 division has a bolt hole 32 in the stator core 31 division. The load side bracket 4 in the first embodiment has 12 tapping holes 41, corresponding to the 12 bolt holes 32 in the stator core 31. Bolts 9 are secured in the tapping holes 41 through the bolt holes 32 in the stator core 31, and thus the stator core 31 divisions are individually secure to the load side bracket 4.

In the first embodiment, as illustrated in FIG. 2, the stator 3 (the stator core 31) includes a plurality of protrusions 33 (12 protrusions 33 in the first embodiment). Around the protrusions 33, two groups of three-phase coils 34 are wound (a group made up of a U phase, a V phase, and a W phase; and a group made up of a u phase, a v phase, and a w phase). The stator 3 also includes a plurality of slots 35 (12 in the first embodiment). The slots 35 are disposed between protrusions 33 next to each other to accept the coils 34. Thus, the stator 3 has 12 slots. The protrusions 33 are examples of the “stator side protrusions”.

In the first embodiment, one group among the two groups of three-phase coils 34 includes the U phase, the V phase, and the W phase, while the other group among the two groups of three-phase coils 34 includes the u phase, the v phase, and the w phase. Through the u phase, the v phase, and the w phase, current flows in directions respectively opposite to the directions in which current flows through the U phase, the V phase, and the W phase. The protrusions 33 include protrusions 33a and protrusions 33b. Around the protrusions 33a, the one group of coils 34 (the U phase, the V phase, and the W phase), among the two groups of three-phase coils 34, is wound. Around the protrusions 33b, the other group of coils 34 (the u phase, the v phase, and the w phase) is wound. When the center of one of the protrusions 33a in a circumferential direction of the switched reluctance motor 100 is aligned with the center of one of the protrusions 22 of the rotor 2 in the circumferential direction, the center of one of the protrusions 33b in the circumferential direction is out of alignment with the center of another one of the protrusions 22 of the rotor 2 in the circumferential direction. In the example illustrated in FIG. 2, the center of the protrusion 33a in the circumferential direction around which the V phase coil 34 is wound is aligned with the center of one of the protrusions 22 in the circumferential direction, whereas the centers in the circumferential direction of the protrusions 33b, around which the u phase coil 34, the v phase coil 34, and the w phase coil 34, are wound are out of alignment with the centers in the circumferential direction of the other protrusions 22. The protrusions 33a are examples of the “stator side protrusions”, the “first stator side protrusion”, and the “first stator side protrusions”. The protrusions 33b are examples of the “stator side protrusions”, the “second stator side protrusion”, and the “second stator side protrusions”.

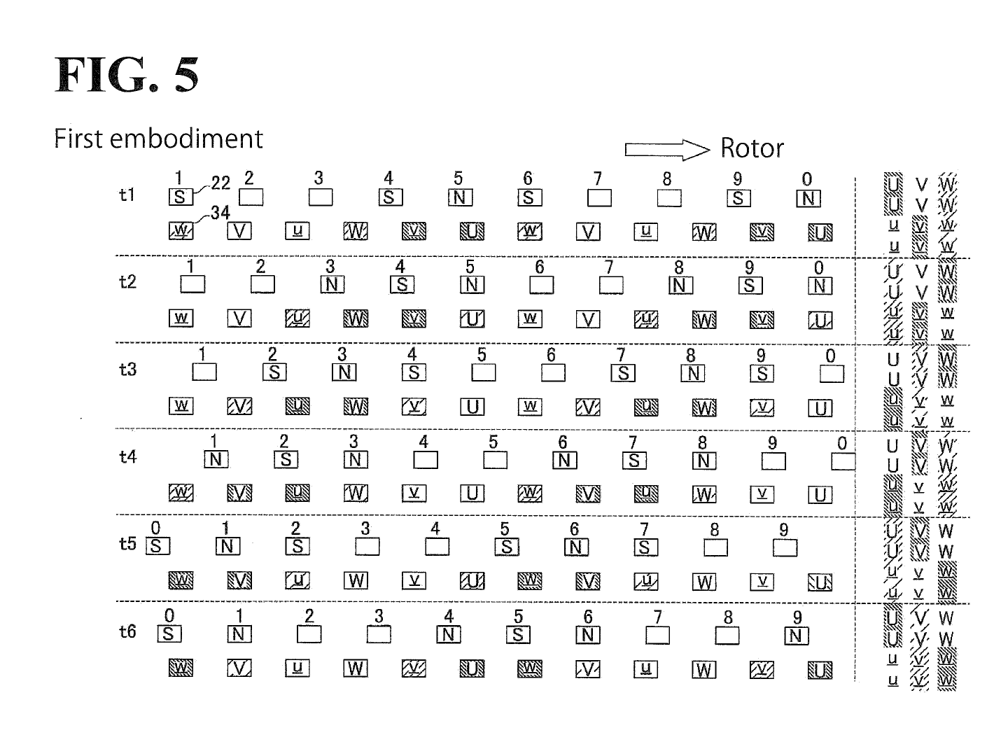

In the first embodiment, the protrusions 33a, around which the U phase coil 34, the V phase coil 34, and the W phase coil 34 are wound, alternate with the protrusions 33b, around which the u phase coil 34, the v phase coil 34, and the w phase coil 34 are wound, in the circumferential direction on the stator 3. Specifically, the coils 34 are disposed on the protrusions 33 of the stator 3 (the stator core 31) in the order of the w phase, the V phase, the u phase, the W phase, the v phase, the U phase, the w phase, the V phase, the u phase, the W phase, the v phase, and the U phase in the circumferential direction (clockwise). Three-phase drive circuits 10a and 10b, described later (see FIG. 4), alternate with each other to be turned on to provide current from one coil 34 to the next coil 34 in the circumferential direction among the coils 34 wound around the protrusions 33a, and to provide current from one coil 34 to the next coil 34 in the circumferential direction among the coils 34 wound around the protrusions 33b, so as to drive the rotor 2. Specifically, the drive circuit 10 (the three-phase drive circuits 10a and 10b) switches from the U phase to the W phase, from the v phase to the u phase, from the W phase to the V phase, from the u phase to the w phase, from the V phase to the U phase, and from the w phase to the v phase (see FIG. 5) in providing current through the coils 34.

As illustrated in FIG. 3, the coils 34 are air core coils 34a of 12 concentrated windings. Each air core coil 34a has a rectangular ring shape, as a result of processing under pressure in a mold. At one end in an axial direction of the 12 air core coils 34a, a connecting plate 34b is disposed. The 12 air core coils 34a and the connecting plate 34b are covered with a mold resin.

In the first embodiment, as illustrated in FIG. 4, the drive circuit 10 includes the three-phase drive circuits 10a and 10b to provide current respectively through the two groups of three-phase coils 34. To the drive circuit 10, a power source 200 is coupled. The three-phase drive circuit 10a includes switching elements 11a, 11b, and 11c, and diodes 12a, 12b, and 12c. The three-phase drive circuit 10b includes switching elements 11d, 11e, and 11f, and diodes 12d, 12e, and 12f. The switching elements 11a, 11b, and 11c of the three-phase drive circuit 10a are coupled in series to one of the two groups of three-phase coils 34, and the switching elements 11d, 11e, and 11f of the three-phase drive circuit 10b are coupled in series to the other group of three-phase coils 34. Specifically, the switching elements 11a, 11b, and 11c are coupled to the U phase coil 34, the V phase coil 34, and the W phase coil 34. The switching elements 11d, 11e, and 11f are coupled to the u phase, the v phase, and the w phase coil 34. The switching elements 11a to 11f are turned on and off to drive the rotor 2.

In the first embodiment, the output terminal of one of the three-phase drive circuits 10a and 10b is coupled to the input terminal the other one of the three-phase drive circuits 10a and 10b. Specifically, the output terminal of the three-phase drive circuit 10a, which provides current through the U phase coil 34, the V phase coil 34, and the W phase coil 34, is coupled at a neutral point N to the input terminal of the three-phase drive circuit 10b, which provides current through the u phase coil 34, the v phase coil 34, and the w phase coil 34. The three-phase drive circuits 10a and 10b are configured such that current through the three-phase drive circuit 10a flows through the three-phase drive circuit 10b. Also, the three-phase drive circuits 10a and 10b alternate with each other to be turned on to drive the rotor 2 (the switched reluctance motor 100).

Next, by referring to FIG. 5, an operation of the switched reluctance motor 100 according to the first embodiment will be described. As illustrated in FIG. 5, numbers (0 to 9) are aligned in a lateral direction to denote the protrusions 22 of the 10-pole rotor 2 along with periods t1 to t6 in a vertical direction. At the right end of each of periods t1 to t6, a column is attached that shows phases through which current is flowing. Phases through which current is flowing at present are densely hatched, while phases through which smaller amounts of current are flowing are roughly hatched. An example of the roughly hatched phases is a phase through which current has just passed.

First, in period t1, the three-phase drive circuit 10a (see FIG. 3) is driven to provide current through the U phase coil 34. Then, the three-phase drive circuit 10b is driven to provide current through the v phase coil 34. That is, in the first embodiment, the three-phase drive circuits 10a and 10b alternate with each other to be turned on to provide current from one coil 34 to the next coil 34 in the circumferential direction among the coils 34 wound around the protrusions 33a, and to provide current from one coil 34 to the next coil 34 in the circumferential direction among the coils 34 wound around the protrusions 33b. In period t1, the fifth protrusion 22 and the 0th protrusion 22 are north pole magnetized, while the first protrusion 22, the fourth protrusion 22, the sixth protrusion 22, and the ninth protrusion 22 are south pole magnetized.

In period t2, current flows through the W phase coil 34, and then current flows through the v phase coil 34. In period t2, the third protrusion 22, the fifth protrusion 22, the eighth protrusion 22, and the 0th protrusion 22 are north pole magnetized, while the fourth protrusion 22 and the ninth protrusion 22 are south pole magnetized. In period t3, current flows through the W phase coil 34, and then current flows through the u phase coil 34. In period t3, the third protrusion 22 and the eighth protrusion 22 are north pole magnetized, while the second protrusion 22, the fourth protrusion 22, the seventh protrusion 22, and the ninth protrusion 22 are south pole magnetized. In period t4, current flows through the V phase coil 34, and then current flows through the u phase coil 34. In period t4, the first protrusion 22, the third protrusion 22, the sixth protrusion 22, and the eighth protrusion 22 are north pole magnetized, while the second protrusion 22 and the seventh protrusion 22 are south pole magnetized.

In period t5, current flows through the V phase coil 34, and then current flows through the w phase coil 34. In period t5, the first protrusion 22 and the sixth protrusion 22 are north pole magnetized, while the 0th protrusion 22, the second protrusion 22, the fifth protrusion 22, and the seventh protrusion 22 are south pole magnetized. In period t6, current flows through the U phase coil 34, and then current flows through the w phase coil 34. In period t6, the first protrusion 22, the fourth protrusion 22, the sixth protrusion 22, and the ninth protrusion 22 are north pole magnetized, while the 0th protrusion 22 and the fifth protrusion 22 are south pole magnetized. By regulating the flow of current in this manner (through repetition of periods t1 to t6), the rotor 2 is rotated in the right direction in FIG. 5.

In the first embodiment, the switched reluctance motor 100 includes the stator 3, and the motor system 110 includes the three-phase drive circuits 10a and 10b, as described above. The stator 3 includes the protrusions 33, around which the two groups of three-phase coils 34 are wound. The three-phase drive circuits 10a and 10b provide current respectively through the two groups of three-phase coils 34. This makes the switched reluctance motor 100 driven on a 6-phase basis in practice (=2×3 phases), and this ensures less of torque ripple than when the switched reluctance motor 100 is driven on a three-phase basis or a five-phase basis. The use of the three-phase drive circuits 10a and 10b, which are general three-phase drive circuits, to provide current respectively through the two groups of three-phase coils 34 eliminates the need for an additional, five-phase drive circuit, for example, in driving the switched reluctance motor 100. This, as a result, ensures less of torque ripple without providing an additional, five-phase drive circuit.

Also in the first embodiment, the three-phase drive circuits 10a and 10b include the switching elements 11a to 11f, as described above. The switching elements 11a to 11f of the three-phase drive circuits 10a and 10b are coupled in series to the two groups of three-phase coils 34. The switching elements 11a to 11f are turned on and off to drive the rotor 2. This facilitates supply of current through the two groups of three-phase coils 34 using the three-phase drive circuits 10a and 10b.

Also in the first embodiment, the output terminal of one of the three-phase drive circuits 10a and 10b is coupled to the input terminal of the other one of the three-phase drive circuits 10a and 10b, as described above. This ensures that the three-phase drive circuits 10a and 10b form a bridge circuit.

Also in the first embodiment, the three-phase drive circuits 10a and 10b are configured such that current through the three-phase drive circuit 10a flows through the three-phase drive circuit 10b, as described above. This ensures that current through the U phase, the V phase, and the W phase readily flows through the u phase, the v phase, and the w phase.

Also in the first embodiment, the three-phase drive circuits 10a and 10b alternate with each other to be turned on so as to drive the rotor 2, as described above. This facilitates control of the three-phase drive circuits 10a and 10b as compared with the case where the three-phase drive circuits 10a and 10b are driven on a random basis.

Also in the first embodiment, the protrusions 33a and the protrusions 33b alternate with each other in the circumferential direction on the stator 3, as described above. This ensures that the three-phase drive circuits 10a and 10b alternate with each other to be turned on to provide current through one of the coils 34 wound around the protrusions 33a and through one of the coils 34 wound around the protrusions 33b, so as to rotate the rotor 2.

Also in the first embodiment, the three-phase drive circuits 10a and 10b alternate with each other to be turned on to provide current from one coil 34 to the next coil 34 in the circumferential direction among the coils 34 wound around the protrusions 33a, and to provide current from one coil 34 to the next coil 34 in the circumferential direction among the coils 34 wound around the protrusions 33b, so as to drive the rotor 2, as described above. This ensures that the coils 34 through which current flows are switched to other coils 34 in orders in the circumferential direction. This, in turn, ensures smooth rotation of the rotor 2.

Also in the first embodiment, the rotor 2 has 10 poles, which corresponds to the number of the protrusions 22, and the stator 3 has 12 slots. This facilitates the configuration in which when the center of one of the protrusions 33a in the circumferential direction is aligned with the center of one of the protrusions 22 in the circumferential direction, the center of one of the protrusions 33b in the circumferential direction is out of alignment with the center of another one of the protrusions 22 in the circumferential direction. This also ensures that the U phase coil 34, the V phase coil 34, and the W phase coil 34 alternate with the u phase coil 34, the v phase coil 34, and the w phase coil 34 in the circumferential direction.

Also in the first embodiment, the coils 34 are disposed on the stator 3 in the order of the w phase, the V phase, the u phase, the W phase, the v phase, the U phase, the w phase, the V phase, the u phase, the W phase, the v phase, and the U phase in the circumferential direction. This ensures that coils 34 of the same phase face each other (that is, are disposed at 180-degree intervals) on the stator 3 (for example, the V phase coil 34 faces the other V phase coil 34). This, in turn, ensures balanced rotation of the rotor 2.

Also in the first embodiment, the three-phase drive circuits 10a and 10b switch from the U phase to the W phase, from the v phase to the u phase, from the W phase to the V phase, from the u phase to the w phase, from the V phase to the U phase, and from the w phase to the v phase in providing current through the coils 34, as described above. This ensures smooth rotation of the rotor 2 in the case where the coils 34 are disposed on the stator 3 in the order of the w phase, the V phase, the u phase, the W phase, the v phase, the U phase, the w phase, the V phase, the u phase, the W phase, the v phase, and the U phase in the circumferential direction. In servo motor applications and other similar applications in which reduction in torque ripple is a major requirement, it is highly effective to combine this embodiment with current level control technology to reduce torque ripple.

### Second Embodiment

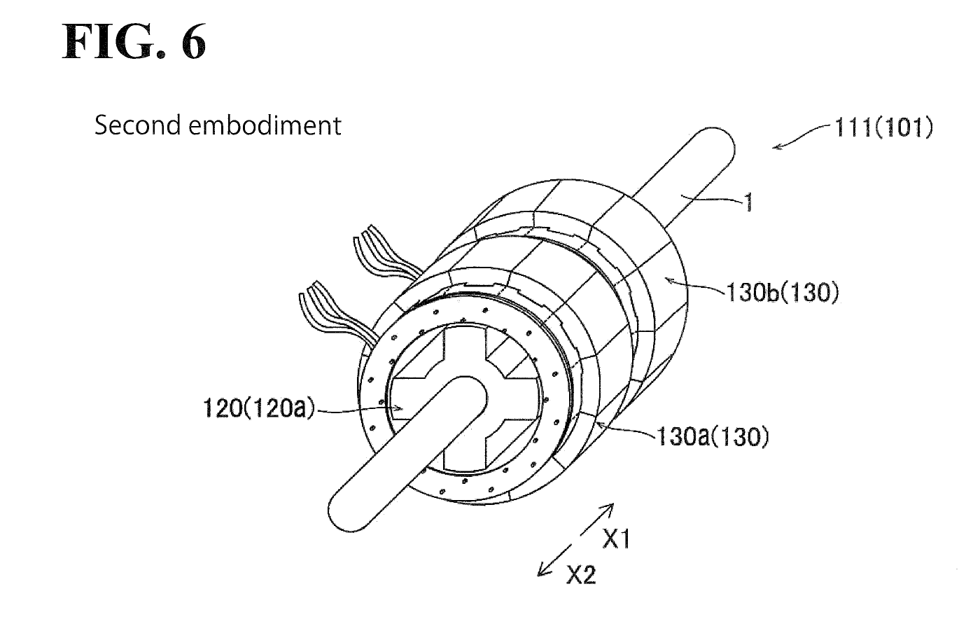

Next, by referring to FIGS. 6 to 9, a configuration of a motor system 111 according to the second embodiment (switched reluctance motor 101) will be described. The second embodiment is different from the first embodiment, in which the U phase coil 34, the V phase coil 34, and the W phase coil 34 alternate with the u phase coil 34, the v phase coil 34, and the w phase coil 34 in the circumferential direction on the stator 3. In the second embodiment, the U phase coil 34, the V phase coil 34, and the W phase coil 34 are adjacent to the u phase coil 34, the v phase coil 34, and the w phase coil 34 in an axial direction of the switched reluctance motor 101. The switched reluctance motor 101 is an example of the “motor”.

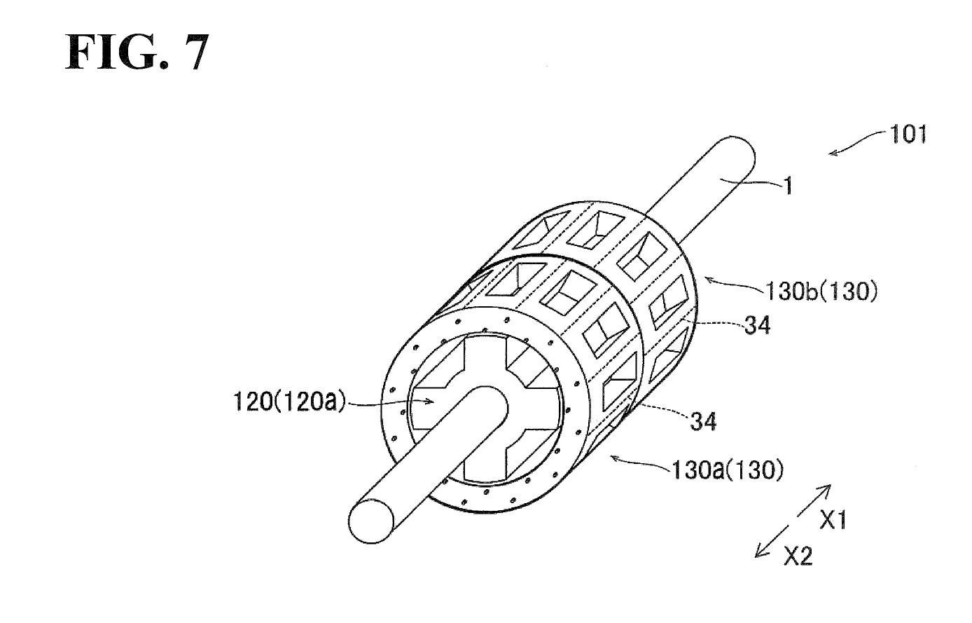

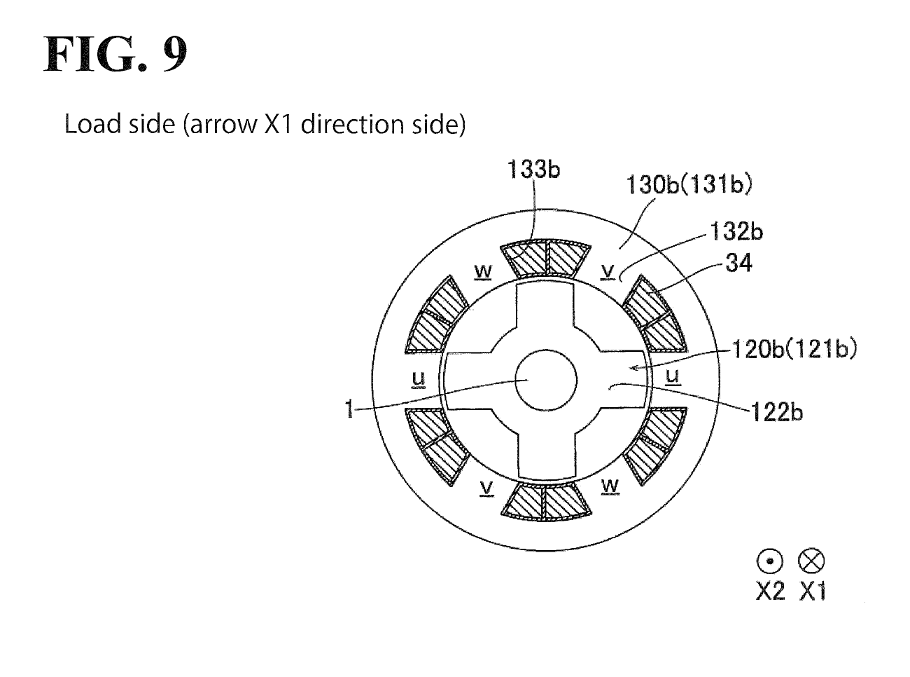

As illustrated in FIGS. 6 and 7, the switched reluctance motor 101 according to the second embodiment includes a shaft 1, a rotor 120 (rotors 120a and 120b, see FIG. 9), and a stator 130 (stators 130a and 130b). It is noted that FIGS. 6 and 7 omit illustration of the load side bracket 4 (see FIG. 1), the anti-load side bracket 5, the frame 6, and the encoder 7. The rotor 120a is an example of the “mover” and the “first mover”. The rotor 120b is an example of the “mover” and the “second mover”.

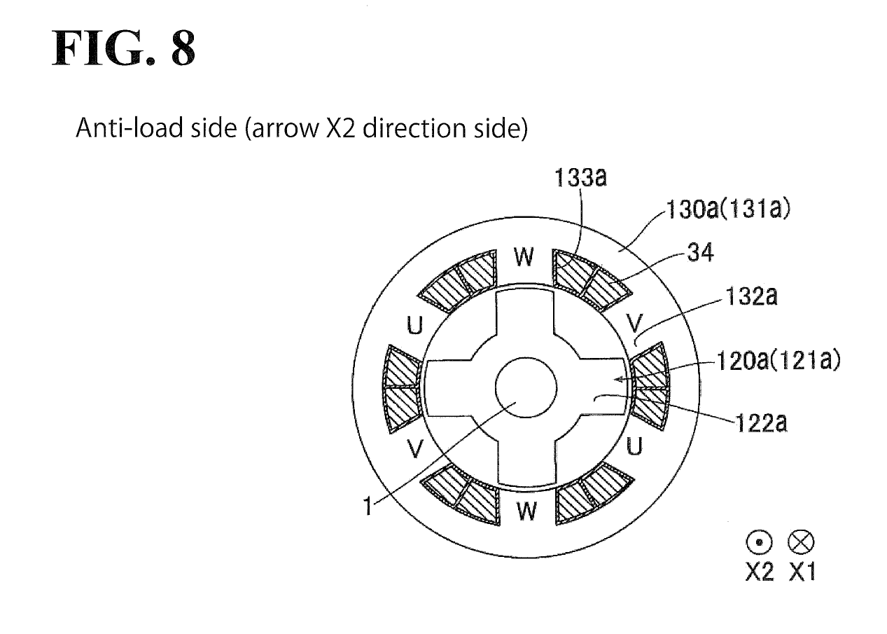

In the second embodiment, as illustrated in FIG. 8, the rotor 120a (rotor core 121a) includes a plurality of protrusions 122a (four protrusions 122a in the second embodiment). That is, the rotor 120a has four poles, which corresponds to the number of the protrusions 122a. Also as illustrated in FIG. 9, the rotor 120b (rotor core 121b) includes a plurality of protrusions 122b (four protrusions 122b in the second embodiment). That is, the rotor 120b has four poles, which corresponds to the number of the protrusions 122b. As illustrated in FIGS. 6 and 7, the rotor 120a and the rotor 120b are adjacent to each other in the axial direction (length direction of the shaft 1). The protrusions 122a and 122b are examples of the “mover side protrusions”.

Also in the second embodiment, as illustrated in FIGS. 8 and 9, the stator 130 includes the stator 130a (stator core 131a) and the stator 130b (stator core 131b). The stator 130a includes protrusions 132a, and the stator 130b includes protrusions 132b. As illustrated in FIGS. 6 and 7, the stator 130a (the U phase coil 34, the V phase coil 34, and the W phase coil 34) and the stator 130b (the u phase coil 34, the v phase coil 34, and the w phase coil 34) are adjacent to each other in the axial direction (length direction of the shaft 1). The rotor 120a and the rotor 120b are respectively opposed to the stator 130a and the stator 130b. As illustrated in FIGS. 8 and 9, the stator 130a and the stator 130b have such relative positions that the protrusions 132a of the stator 130a and the protrusions 132b of the stator 130b alternate with each other in a view in the axial direction. The protrusions 122a of the rotor 120a and the protrusions 122b of the rotor 120b overlap with each other in the view in the axial direction. The stator 130a is an example of the “stator” and the “first stator”. The stator 130b is an example of the “stator” and the “second stator”. The protrusions 132a are examples of the “stator side protrusions”, the “first stator side protrusion”, and the “first stator side protrusions”. The protrusions 132b are examples of the “stator side protrusions”, the “second stator side protrusion”, and the “second stator side protrusions”.

The protrusions 132a and the protrusions 132 are adjacent to each other in the axial direction. The three-phase drive circuit 10a (see FIG. 4) is coupled to the coils 34 wound around the protrusions 132a, and the three-phase drive circuit 10b (see FIG. 4) is coupled to the coils 34 wound around the protrusions 132b. Then, the three-phase drive circuits 10a and 10b alternate with each other to be turned on so as to drive the rotors 120a and 120b.

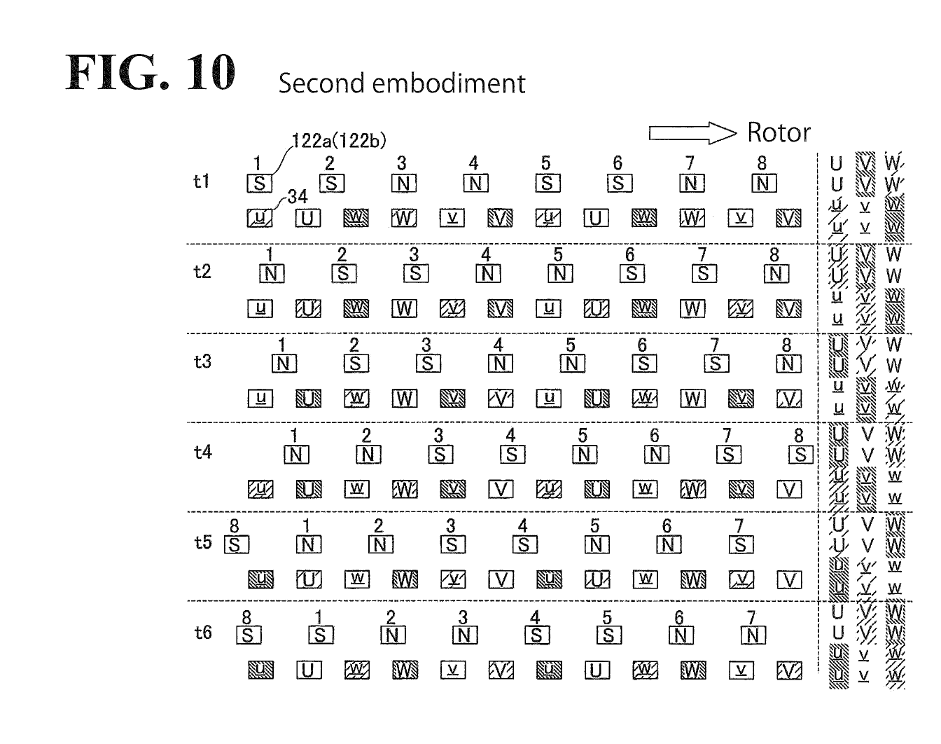

Also in the second embodiment, the stator 130a (the stator 130b) includes a plurality of slots 133a (133b) (six slots in the second embodiment). The slots 133a (133b) are disposed between protrusions 132a (protrusions 132b) next to each other to accept the coils 34. Thus, the stator 130a and the stator 130b respectively have six slots. As illustrated in FIG. 8, the coils 34 are disposed on the stator 130a in the order of the U phase, the W phase, the V phase, the U phase, the W phase, and the V phase in the circumferential direction (clockwise). As illustrated in FIG. 9, the coils 34 are disposed on the stator 130b in the order of the u phase, the w phase, the v phase, the u phase, the w phase, and the v phase in the circumferential direction (clockwise). The three-phase drive circuits 10a and 10b switch from the V phase to the U phase, from the w phase to the v phase, from the U phase to the W phase, from the v phase to the u phase, from the W phase to the V phase, and from the u phase to the w phase (see FIG. 10) in providing current through the coils 34.

Next, by referring to FIG. 10, an operation of the switched reluctance motor 101 according to the second embodiment will be described. FIG. 10 is similar to FIG. 5 (first embodiment) in that numbers (1 to 8) are aligned in the lateral direction to denote the protrusions 122a and the protrusions 122b of the 8-pole (2×4 poles) rotor 120 along with periods t1 to t6 in the vertical direction.

First, in period t1, three-phase drive circuit 10a (see FIG. 3) is driven to provide current through the V phase coil 34. Then, the three-phase drive circuit 10b is driven to provide current through the w phase coil 34. In period t1, the third protrusion 122a (protrusion 122b), the fourth protrusion 122a (protrusion 122b), the seventh protrusion 122a (protrusion 122b), and the eighth protrusion 122a (protrusion 122b) are north pole magnetized, while the first protrusion 122a (protrusion 122b), the second protrusion 122a (protrusion 122b), the fifth protrusion 122a (protrusion 122b), and the sixth protrusion 122a (protrusion 122b) are south pole magnetized.

In period t2, current flows through the V phase coil 34, and then current flows through the w phase coil 34. In period t2, the first protrusion 122a (protrusion 122b), the fourth protrusion 122a (protrusion 122b), the fifth protrusion 122a (protrusion 122b), and the eighth protrusion 122a (protrusion 122b) are north pole magnetized, while the second protrusion 122a (protrusion 122b), the third protrusion 122a (protrusion 122b), the sixth protrusion 122a (protrusion 122b), and the seventh protrusion 122a (protrusion 122b) are south pole magnetized. In period t3, current flows through the U phase coil 34, and then current flows through the v phase coil 34. In period t3, the first protrusion 22, the fourth protrusion 122a (protrusion 122b), the fifth protrusion 122a (protrusion 122b), and the eighth protrusion 122a (protrusion 122b) are north pole magnetized, while the second protrusion 122a (protrusion 122b), the third protrusion 122a (protrusion 122b), the sixth protrusion 122a (protrusion 122b), and the seventh protrusion 122a (protrusion 122b) are south pole magnetized.

In period t4, current flows through the U phase coil 34, and then current flows through the v phase coil 34. In period t4, the first protrusion 122a (protrusion 122b), the second protrusion 122a (protrusion 122b), the fifth protrusion 122a (protrusion 122b), and the sixth protrusion 122a (protrusion 122b) are north pole magnetized, while the third protrusion 122a (protrusion 122b), the fourth protrusion 122a (protrusion 122b), the seventh protrusion 122a (protrusion 122b), and the eighth protrusion 122a (protrusion 122b) are south pole magnetized. In period t5, current flows through the W phase coil 34, and then current flows through the u phase coil 34. In period t5, the first protrusion 122a (protrusion 122b), the second protrusion 122a (protrusion 122b), the fifth protrusion 122a (protrusion 122b), and the sixth protrusion 122a (protrusion 122b) are north pole magnetized, while the third protrusion 122a (protrusion 122b), the fourth protrusion 122a (protrusion 122b), the seventh protrusion 122a (protrusion 122b), and the eighth protrusion 122a (protrusion 122b) are south pole magnetized.

In period t6, current flows through the W phase coil 34, and then current flows through the u phase coil 34. In period t6, the second protrusion 122a (protrusion 122b), the third protrusion 122a (protrusion 122b), the sixth protrusion 122a (protrusion 122b), and the seventh protrusion 122a (protrusion 122b) are north pole magnetized, while the first protrusion 122a (protrusion 122b), the fourth protrusion 122a (protrusion 122b), the fifth protrusion 122a (protrusion 122b), and the eighth protrusion 122a (protrusion 122b) are south pole magnetized. By regulating the flow of current in this manner (through repetition of periods t1 to t6), the rotor 120 is rotated in the right direction in FIG. 10.

In the second embodiment, the stator 130 includes the stator 130a and the stator 130b, as described above. The stator 130a includes the protrusions 132a, and the stator 130b includes the protrusions 132b. The stator 130a and the stator 130b are adjacent to each other in the axial direction. This facilitates driving of the switched reluctance motor 101 on a 6-phase basis in practice (=2×3 phases) using the stator 130a and the stator 130b (switched reluctance motor), which are general stators inherently involving higher levels of torque ripple. This, in turn, ensures less of torque ripple than when the switched reluctance motor 101 is driven on a three-phase basis or a five-phase basis.

Also in the second embodiment, the stator 130a and the stator 130b have such relative positions that the protrusions 132a of the stator 130a and the protrusions 132b of the stator 130b alternate with each other in a view in the axial direction, as described above. This ensures that the three-phase drive circuits 10a and 10b alternate with each other to be turned on to alternately provide current through the protrusions 132a and the protrusions 132b so as to rotate the rotor 120.

Also in the second embodiment, the protrusions 132a and the protrusions 132 are adjacent to each other in the axial direction, as described above. The three-phase drive circuit 10a is coupled to the coils 34 wound around the protrusions 132a, and the three-phase drive circuit 10b is coupled to the coils 34 wound around the protrusions 132b. The three-phase drive circuits 10a and 10b alternate with each other to be turned on so as to drive the rotor 120. This facilitates the attempt to reduce torque ripple using the switched reluctance motor, which is a general switched reluctance motor inherently involving higher levels of torque ripple, and using the three-phase drive circuits 10a and 10b, which are general three-phase drive circuits.

Also in the second embodiment, the rotor 120 has four poles, which corresponds to the number of the protrusions 122a (protrusion 122b), and the stator 130a and the stator 130b each have six slots, as described above. This facilitates the configuration in which when the center of one of the protrusions 132a in the circumferential direction is aligned with the center of one of the protrusions 122a in the circumferential direction, the center of one of the protrusions 132b in the circumferential direction is out of alignment with the center of one of the protrusions 122b in the circumferential direction. This also ensures that in a view in the axial direction, the U phase coil 34, the V phase coil 34, and the W phase coil 34 alternate with the u phase coil 34, the v phase coil 34, and the w phase coil 34 in the circumferential direction.

Also in the second embodiment, the coils 34 are disposed on the stator 130a in the order of the U phase, the W phase, the V phase, the U phase, the W phase, and the V phase in the circumferential direction, while the coils 34 are disposed on the stator 130b in the order of the u phase, the w phase, the v phase, the u phase, the w phase, and the v phase in the circumferential direction, as described above. This ensures that coils 34 of the same phase face each other (that is, are disposed at 180-degree intervals) on the stator 130a and the stator 130b (for example, the V phase coil 34 faces the other V phase coil 34). This, in turn, ensures balanced rotation of the rotor 120.

Also in the second embodiment, the three-phase drive circuits 10a and 10b switch from the V phase to the U phase, from the w phase to the v phase, from the U phase to the W phase, from the v phase to the u phase, from the W phase to the V phase, and from the u phase to the w phase in providing current through the coils 34, as described above. This ensures smooth rotation of the rotor 120 in the case where the coils 34 are disposed on the stator 130a in the order of the U phase, the W phase, the V phase, the U phase, the W phase, and the V phase in the circumferential direction, and the coils 34 are disposed on the stator 130b in the order of the u phase, the w phase, the v phase, the u phase, the w phase, and the v phase in the circumferential direction.

### Third Embodiment

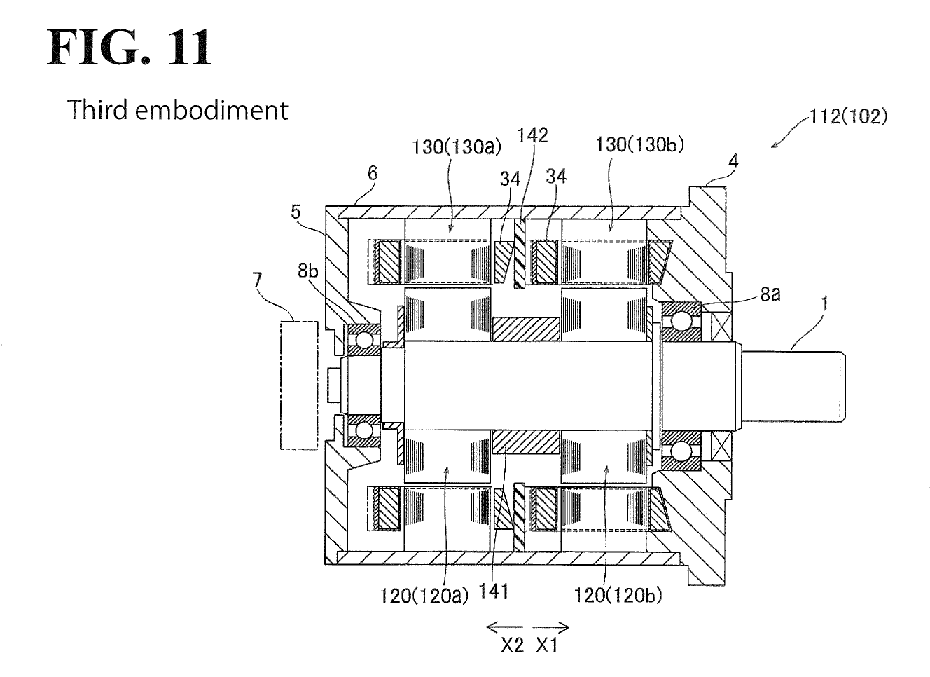

Next, by referring to FIG. 11, a configuration of a motor system 112 according to the third embodiment (switched reluctance motor 102) will be described. In the third embodiment, a magnet 141 is disposed between the rotor 120a and the rotor 120b of the switched reluctance motor 101 according to the second embodiment. The switched reluctance motor 102 is an example of the “motor”.

As illustrated in FIG. 11, the switched reluctance motor 102 according to the third embodiment includes the shaft 1, the rotor 120 (rotors 120a and 120b), and the stator 130 (stators 130a and 130b). Between the stator 130a and the stator 130b, a connecting plate 142 is disposed. The connecting plate 142 connects the coils 34 wound around the stator 130a to the coils 34 wound around the stator 130b.

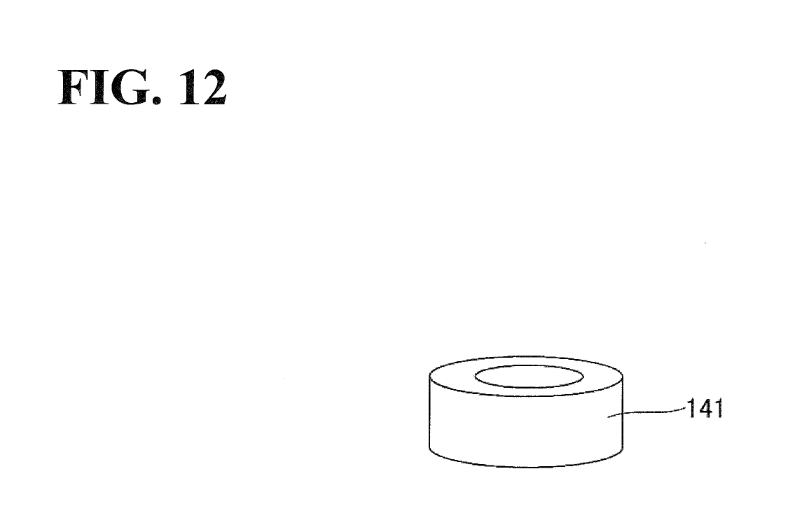

In the third embodiment, the magnet 141 is disposed over a portion of the shaft 1 located between the rotor 120a and the rotor 120b. The magnet 141 surrounds the shaft 1 to effect a dynamic brake (which is braking force effected by short-circuit of the coils 34). As illustrated in FIG. 12, the magnet 141 has a ring shape. The shaft 1 is made of a nonmagnetic member (examples including, but not limited to, stainless and SUS 316). The third embodiment is otherwise similar to the second embodiment.

In the third embodiment, the rotor 120a is coupled to the shaft 1 and opposed to the stator 130a, and the rotor 120b is coupled to the shaft 1 and opposed to the stator 130b, as described above. The magnet 141 is disposed over a portion of the shaft 1 located between the rotor 120a and the rotor 120b. The magnet 141 surrounds the shaft 1 to effect the dynamic brake. This facilitates providing a dynamic brake function to the switched reluctance motor, which is generally without the dynamic brake function.

Also in the third embodiment, the magnet 141 has a ring shape surrounding the shaft 1, as described above. This ensures that the shaft 1 is surrounded by the magnet 141, causing the dynamic brake to function effectively.

Also in the third embodiment, the shaft 1 is made of stainless, which is a nonmagnetic member, as described above. This eliminates or minimizes inflow of part of the flux of the magnet 141 into the shaft 1 (thereby preventing degradation of the flux of the magnet 141), as compared with the case where the shaft 1 is made of a magnetic member. This, as a result, eliminates or minimizes degradation of the dynamic brake function (which is a function as brake).

In the first to third embodiments, the pair of three-phase drive circuits are configured such that current flows from the three-phase drive circuit that provides current through the U phase coil, the V phase coil, and the W phase coil to the three-phase drive circuit that provides current through the u phase coil, the v phase coil, and the w phase coil. Another possible example is that current flows from the three-phase drive circuit that provides current through the u phase coil, the v phase coil, and the w phase coil to the three-phase drive circuit that provides current through the U phase coil, the V phase coil, and the W phase coil.

While the first to third embodiments are rotary motor applications, other possible applications include linear motor applications and other motor applications of other than rotary nature.

While in the first embodiment the rotor has 10 poles and the stator has 12 slots, the rotor may have 10n poles (n is a natural number equal to or more than two) and the stator may have 12n slots (n is a natural number equal to or more than two).

Also in the first embodiment, the coils of the U phase, the V phase, and the W phase alternate with the coils of the u phase, the v phase, and the w phase in the circumferential direction on the stator. Another possible example is that the coils of the U phase, the V phase, and the W phase do not alternate with the coils of the u phase, the v phase, and the w phase in the circumferential direction on the stator.

In the second embodiment, the protrusions 132a of the stator 130a and the protrusions 132b of the stator 130b alternate with each other in a view in the axial direction. Another possible example is that the protrusions 132a of the stator 130a and the protrusions 132b of the stator 130b overlap with each other in a view in the axial direction, while at the same time the protrusions 122a of the rotor 120a and the protrusions 122b of the rotor 120b alternate with each other in the view in the axial direction.

In the second embodiment, the rotor 120 has four poles and the stator 130a and the stator 130b respectively have six slots. Another possible example is that the rotor 120 has 2n poles (n is a natural number such as one, and equal to or more than three), and the stator 130a and the stator 130b respectively have 3n slots (n is a natural number such as one, and equal to or more than three).

While in the third embodiment the shaft is made of stainless, which is a nonmagnetic member, another possible example is that the shaft is made of a nonmagnetic member other than stainless.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A motor system comprising:
a motor comprising:
a mover comprising a plurality of mover side protrusions; and
a stator comprising:
first stator side protrusions and second stator side protrusions, wherein when a center of one first stator side protrusion among the first stator side protrusions in a circumferential direction of the motor is aligned with a center of one mover side protrusion among the plurality of mover side protrusions in the circumferential direction, a center of one second stator side protrusion among the second stator side protrusions in the circumferential direction is out of alignment with a center of another mover side protrusion among the plurality of mover side protrusions in the circumferential direction; and
first three-phase coils respectively wound around the first stator side protrusions and second three-phase coils respectively wound around the second stator side protrusions; and
a drive circuit configured to drive the motor, the drive circuit comprising:
a first three-phase drive circuit configured to provide a current through the first three-phase coils; and
a second three-phase drive circuit configured to provide a current through the second three-phase coils.

2. The motor system according to claim 1,
wherein the first three-phase drive circuit comprises a first switching element, and the second three-phase drive circuit comprises a second switching element,
wherein the first switching element is coupled in series to the first three-phase coils, and the second switching element is coupled in series to the second three-phase coils, and
wherein the first switching element and the second switching element are configured to be turned on and off to drive the mover.

3. The motor system according to claim 1, wherein the first three-phase drive circuit comprises an output terminal coupled to an input terminal of the second three-phase drive circuit.

4. The motor system according to claim 3, wherein the current through the first three-phase drive circuit flows through the second three-phase drive circuit.

5. The motor system according to claim 1, wherein the first three-phase drive circuit and the second three-phase drive circuit are configured to alternate with each other to be turned on so as to drive the mover.

6. The motor system according to claim 1, wherein the first stator side protrusions alternate with the second stator side protrusions in the circumferential direction on the stator.

7. The motor system according to claim 6, wherein the first three-phase drive circuit and the second three-phase drive circuit are configured to alternate with each other to be turned on to provide the current from one first three-phase coil to a next first three-phase coil in the circumferential direction, among the first three-phase coils, and to provide the current from one second three-phase coil to a next second three-phase coil in the circumferential direction, among the second three-phase coils, so as to drive the mover.

8. The motor system according to claim 1,
wherein the stator comprises a plurality of first slots each disposed between one first stator side protrusion among the first stator side protrusions and one second stator side protrusion among the second stator side protrusions next to the one first stator side protrusion, the plurality of first slots accepting the first three-phase coils and the second three-phase coils, and
wherein the mover comprises 10n poles corresponding to a number of the plurality of mover side protrusions, n being a natural number equal to or more than one, and the plurality of first slots comprise 12n slots, n being a natural number equal to or more than one.

9. The motor system according to claim 8,
wherein the mover comprises 10 poles, and the plurality of first slots comprise 12 slots,
wherein the first three-phase coils comprise a U phase, a V phase, and a W phase, and the second three-phase coils comprise a u phase, a v phase, and a w phase through which the current is to flow in directions respectively opposite to directions in which the current flows through the U phase, the V phase, and the W phase, and
wherein the first three-phase coils and the second three-phase coils are disposed on the stator in an order of the w phase, the V phase, the u phase, the W phase, the v phase, the U phase, the w phase, the V phase, the u phase, the W phase, the v phase, and the U phase in the circumferential direction.

10. The motor system according to claim 9, wherein the first three-phase drive circuit and the second three-phase drive circuit are configured to switch from the U phase to the W phase, from the v phase to the u phase, from the W phase to the V phase, from the u phase to the w phase, from the V phase to the U phase, and from the w phase to the v phase in providing the current through the first three-phase coils and the second three-phase coils.

11. The motor system according to claim 1,
wherein the stator comprises
a first stator on which the first stator side protrusions are disposed, and
a second stator on which the second stator side protrusions are disposed, and
wherein the first stator and the second stator are adjacent to each other in an axial direction of the motor.

12. The motor system according to claim 11, wherein the first stator and the second stator have such relative positions that the first stator side protrusions and the second stator side protrusions alternate with each other in a view in the axial direction.

13. The motor system according to claim 11,
wherein the first three-phase coils respectively wound around the first stator side protrusions are adjacent in the axial direction to the second three-phase coils respectively wound around the second stator side protrusions,
wherein the first three-phase drive circuit is coupled to the first three-phase coils, and the second three-phase drive circuit is coupled to the second three-phase coils, and
wherein the first three-phase drive circuit and the second three-phase drive circuit alternate with each other to be turned on so as to drive the mover.

14. The motor system according to claim 11,
wherein the first stator comprises a plurality of second slots each disposed between one first stator side protrusion and another first stator side protrusion, among the first stator side protrusions, that are next to each other in the circumferential direction, the plurality of second slots accepting the first three-phase coils,
wherein the second stator comprises a plurality of third slots each disposed between one second stator side protrusion and another second stator side protrusion, among the second stator side protrusions, that are next to each other in the circumferential direction, the plurality of third slots accepting the second three-phase coils,
wherein the mover comprises 2n poles corresponding to the number of the plurality of mover side protrusions, n being a natural number equal to or more than one, and
wherein the plurality of second slots comprise 3n slots, and the plurality of third slots comprise 3n slots, n being a natural number equal to or more than one.

15. The motor system according to claim 14,
wherein the mover comprises four poles,
wherein the plurality of second slots comprise six slots, and the plurality of third slots comprise six slots,
wherein the first three-phase coils comprise a U phase, a V phase, and a W phase, and the second three-phase coils comprise a u phase, a v phase, and a w phase through which the current is to flow in directions respectively opposite to directions in which the current flows through the U phase, the V phase, and the W phase, and
wherein the first three-phase coils are disposed on the first stator in an order of the U phase, the W phase, the V phase, the U phase, the W phase, and the V phase in the circumferential direction, and the second three-phase coils are disposed on the second stator in an order of the u phase, the w phase, the v phase, the u phase, the w phase, and the v phase in the circumferential direction.

16. The motor system according to claim 15, wherein the first three-phase drive circuit and the second three-phase drive circuit are configured to switch from the V phase to the U phase, from the w phase to the v phase, from the U phase to the W phase, from the v phase to the u phase, from the W phase to the V phase, and from the u phase to the w phase in providing the current through the first three-phase coils and the second three-phase coils.

17. The motor system according to claim 11,
wherein the motor comprises a shaft, and the mover comprises a first mover and a second mover, the first mover being coupled to the shaft and opposed to the first stator, the second mover being coupled to the shaft and opposed to the second stator, and
wherein the motor comprises a magnet on and surrounding the shaft between the first mover and the second mover.

18. The motor system according to claim 17, wherein the shaft comprises a nonmagnetic member.

19. A motor comprising:
a mover comprising a plurality of mover side protrusions; and
a stator comprising:
first stator side protrusions and second stator side protrusions, wherein when a center of one first stator side protrusion among the first stator side protrusions in a circumferential direction of the motor is aligned with a center of one mover side protrusion among the plurality of mover side protrusions in the circumferential direction, a center of one second stator side protrusion among the second stator side protrusions in the circumferential direction is out of alignment with a center of another mover side protrusion among the plurality of mover side protrusions in the circumferential direction; and
first three-phase coils respectively wound around the first stator side protrusions and second three-phase coils respectively wound around the second stator side protrusions, the first three-phase coils and the second three-phase coils being provided with a current respectively from a pair of three-phase drive circuits.

20. A drive circuit applicable to a motor, the motor comprising:
a mover comprising a plurality of mover side protrusions; and
a stator comprising:
first stator side protrusions and second stator side protrusions, wherein when a center of one first stator side protrusion among the first stator side protrusions in a circumferential direction of the motor is aligned with a center of one mover side protrusion among the plurality of mover side protrusions in the circumferential direction, a center of one second stator side protrusion among the second stator side protrusions in the circumferential direction is out of alignment with a center of another mover side protrusion among the plurality of mover side protrusions in the circumferential direction; and
first three-phase coils respectively wound around the first stator side protrusions and second three-phase coils respectively wound around the second stator side protrusions, the first three-phase coils and the second three-phase coils being provided with a current respectively from a pair of three-phase drive circuits.
